(19) United States
(12) Patent Application Publication
(10) Pub. No.: US 2019/0024500 A1
(43) Pub. Date: Jan. 24, 2019

(54) Method and System for Improving Quality of Directional Surveys

(71) Applicant: Surcon, Ltd.

(72) Inventors: Jarrod Shawn DeVerse, Greenwood Village, CO (US); Stefan Maus, Boulder, CO (US)

(21) Appl. No.: 15/741,478

(22) PCT Filed: Jul. 7, 2016
(86) PCT No.: PCT/US16/41394

§ 371 Date: Jan. 2, 2018

Related U.S. Application Data
(60) Provisional application No. 62/189,726, filed on Jul. 7, 2015.

(51) Int. Cl. E21B 47/022; G01V 1/48; E21B 47/12

(52) U.S. Cl. CPC E21B 47/022; G01V 1/48; G01V 2200/16; G01V 2200/14; E21B 47/124

(57) ABSTRACT

A method of improving quality of directional surveys includes receiving from a first location raw survey data acquired by a survey tool configured to make a survey measurement from a wellbore. The quality of the raw survey data is verified using at least one quality control metric. The verified raw survey data is stored in a database in a cloud.

### CROSS-REFERENCE TO RELATED APPLICATIONS

This application claims priority to and the benefit of U.S. Provisional Application No. 62/189,726, filed 7 Jul. 2015, and International Patent Application No. PCT/US2016/041394, filed 7 Jul. 2016, both of which are hereby incorporated herein by reference in their entirety.

### BACKGROUND

Directionally drilled oil and gas wells use downhole MWD (measurement while drilling) instruments to acquire survey information necessary for steering and wellbore placement. MWD instruments house three accelerometers and three magnetometers positioned in three orthogonal axes. This combination of sensors allows for complete measurement of the Earth's magnetic and gravitational fields. As a result, MWD instruments can compute inclination and direction of the wellbore by measuring the MWD instrument's orientation with respect to the gravity and magnetic reference field vectors. Such a measurement at a single point or “station” is called a survey. The wellbore position is computed from a sequence of surveys taken along the wellbore.

Standard MWD surveying is subject to numerous error sources, which can lead to inaccurate wellbore placement. These sources of error are divided into three categories: gross, random, and systematic. Gross errors occur from human mistakes, instrument failure, or environmental factors that cannot be predicted or estimated. Random and systematic errors occur with some measure of predictability and can therefore be estimated and quantified. The standard approach for estimating positional uncertainty in the wellbore caused by random and systematic survey errors is to use instrument performance models called tool codes. Tool codes provide the mathematical frame to compute Ellipsoids of Uncertainty (EOUs), which represent positional uncertainty evaluated at a particular sigma or confidence level. (The Operator's Wellbore Survey Group (OWSG) publishes a set of Instrument Performance Models that enables the computation of EOUs for specific surveying methods. This consolidated set is referred to as the OWSG set of tool codes, or simply tool codes.) The MWD tool code used for EOU and anti-collision calculations specifies the permissible magnitude of the various error terms. The MWD tool code also assumes that surveys are free of gross error, since gross error cannot be predicted or modeled. To validate EOU and anti-collision scans, it is therefore essential to quality control (QC) MWD measurements to verify that they are free of gross errors and do not contain excessive random or systematic errors. If the quality control step is not, performed, then there can be very little confidence that the tool code is representative of the actual errors in the wellbore position.

There are three values computed from MWD survey measurements which can be used for QC purposes. They are B total (strength of the magnetic field), Dip (direction of magnetic field with respect to horizontal plane), and G total (strength of the gravity field). (See, Ekseth, Roger, et al., “High-Integrity Wellbore Surveys: Methods for Eliminating Gross Errors,” Presented at the SPE/IADC Drilling Conference, Amsterdam, 20-22 February. SPE-105558-MS). These measurements are used as metrics for survey quality, because regardless of the orientation of the wellbore and bottom-hole assembly (BHA,) the measured B total, Dip, and G total should be equal to the values provided by the geomagnetic and gravity reference models. Therefore, any differences between the measured values and reference values (Δ B total, Δ Dip, and Δ G total) can be attributed to some combination of measurement error and reference error. This concept is the basis for standard single-station MWD survey quality control tests.

It is common in standard MWD surveying practice to rely on these single-station tests as the only metric for survey quality assurance. However, these tests are considerably lacking in their ability to fully validate the assumptions made by the tool code. (See, Ekseth, Roger, et al., “The Reliability Problem Related to Directional Survey Data,” Presented at the IADC/SPE Asia Pacific Drilling Technology Conference and Exhibition held in Bangkok, Thailand, 13-15, Nov. 2006, IADC/SPE 103734.) For instance, typical quality control (QC) tolerances used by MWD contractors for passing or failing surveys are often arbitrary. Furthermore, it is not enough to evaluate each survey individually because single-station QC tests are extremely limited in their ability to distinguish different types of error. Finally, single-station QC tests are not capable of detecting certain types of gross human errors such as applying an incorrect north reference or misreporting the final survey measurement.

Independent survey quality validation and analysis requires specialized tools and skillsets that are not readily available to most rig site personnel. As a result, the most powerful form of survey quality assurance comes from independent and expert analysis by specialized processionals in remote operating centers. However, historically, it, has been challenging to transfer the necessary MWD survey data to remote centers without compromising data integrity or adding cumbersome and time-consuming steps to the drilling process. The current practice is for rig personnel to download or copy the raw survey measurements from the MWD decoding software and send them to a remote processing center via email in the form of an attached spreadsheet or text file. The data then gets transferred from the emailed file into a particular format that enables survey processing software to process and correct the surveys. Survey corrections are then sent back to the rig site personnel via email.

A standard exists for communicating rig data called Wellsite Information Transfer Standard Markup Language (WITSML). The purpose of WITSML is to serve as a common language for all data to be transferred from the rig site to remote locations where the data are processed and evaluated. There are WITSML aggregators that receive data at the rig site, convert the data to WITSML, and transmit the data to a WITSML server through an Internet connection or satellite uplink. See, for example, U.S. Pat. No. 8,615,660 to Selman et al., “Cloud computing system for real-time streaming, of well, logging data, with self-aligning satellites,” 24 Dec. 2013. Currently, there is no standard protocol for transmitting all types of data, particularly raw MWD survey measurements. This creates a challenge when trying to send this data type to WITSML servers via a WITSML aggregator.

### SUMMARY

In one aspect, a method of improving quality of directional surveys includes receiving from a first location raw survey data acquired by a survey tool configured to make a survey measurement from a wellbore. The method further includes verifying the quality of the raw survey data using at least one quality control metric. The method further includes storing the verified raw survey data in a database in a cloud. The receiving, verifying, and storing are accomplished with one or more processors.

In another aspect, a method of improving quality of directional surveys includes making a survey measurement at a selected position in a wellbore using a survey tool arranged in the wellbore. The method further includes extracting raw survey data from an output of the survey tool at a first location. The method further includes submitting the raw survey data to a web application from the first location, thereby causing the web application to receive the raw survey data from the first location, verify the quality of the raw survey data using at least one quality metric, and add the verified raw survey data to a database.

The method may include retrieving the verified survey data from the database from a second location that is remote from the first location. The method may include performing at least one corrective survey data analysis on the verified survey data. The method may include applying at least one survey correction to the verified survey data based on a result of the at least one corrective survey data analysis. The method may include submitting the corrected survey data to the web application, thereby causing the web application to add the corrected survey data to the database and display the corrected survey data at the first location.

In another aspect, a computer program product includes non-transitory computer readable medium and computer readable code embodied on the non-transitory computer readable medium for improving quality of directional surveys. The computer readable code includes computer readable program code adapted to cause a computer to effect receiving raw survey data from a first location. The computer readable code further includes computer readable program code adapted to cause a computer to effect verifying the quality of the raw survey data using at least one quality control metric. The computer readable code further includes computer readable program code adapted to cause a computer to effect storing the verified raw survey data in a database in a cloud.

In another aspect, a system for improving quality of directional surveys includes a database located in a cloud. The system further includes one or more processors operating to receive raw survey data from a first location, verify the quality of the raw survey data using at least one quality control metric, and store the verified raw survey data in the database.

### BRIEF DESCRIPTION OF DRAWINGS

The following is a description of the figures in the accompanying drawings. The figures are not necessarily to scale, and certain figures and certain views of the figures may be shown exaggerated in scale or in schematic in the interest of clarity and conciseness.

FIG. 1 is a block diagram of a survey quality assurance tool in an example environment.

FIG. 2 illustrates a method of communicating rig site data from a rig site to a remote operating center using the survey quality assurance tool of FIG. 1.

FIGS. 3 and 4 show an example process workflow for survey quality assurance and MWD data transfer using the survey quality assurance tool of FIG. 1.

### DETAILED DESCRIPTION

A survey quality assurance tool that facilitates quality control and correction of survey data is disclosed herein. In one embodiment, the survey quality assurance tool provides an interface between rig site users and remote operating centers using web technology. The survey quality assurance tool optimizes the transfer of directional survey data from rig site to remote operating centers in such a way that minimizes time-consuming steps while simultaneously providing automatic data validation ensuring data integrity. The survey quality assurance tool is a leap forward from traditional methods of emailing text files and spreadsheets between end users because it not only speeds up the entire process but also significantly reduces the occurrence of transcription and clerical errors. The survey quality assurance tool is easily accessible almost anywhere in the world by simply logging in through a standard web browser. This eliminates the need for specialized software at the rig site and remote operating centers.

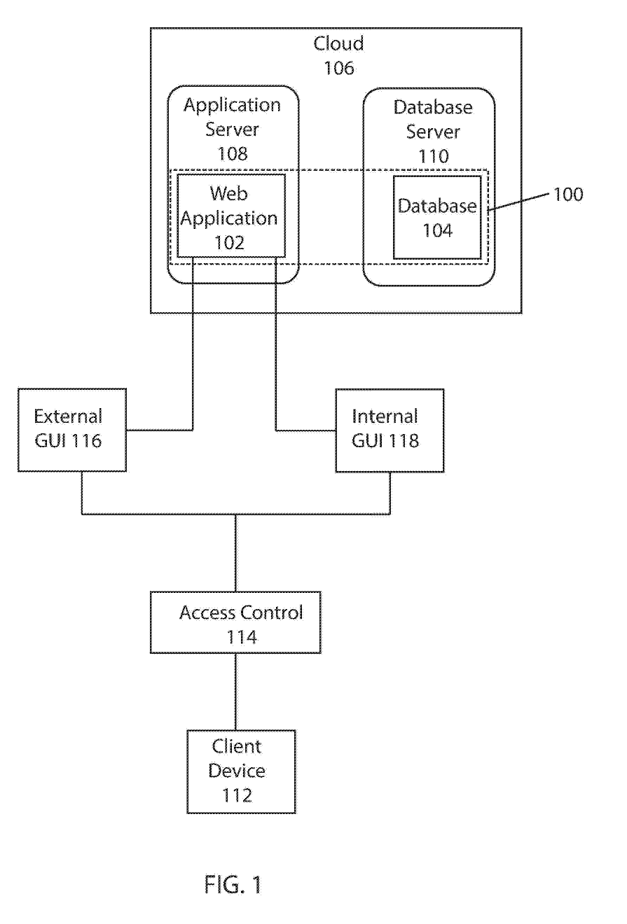

FIG. 1 is a simplified diagram of an illustrative survey quality assurance tool 100 in an example environment. The survey quality assurance tool 100 includes a web application 102 and a database 104. As used herein, the term “web application” refers to an application program that is stored on a remote server and delivered over the Internet through a browser interface. The web application 102 includes logic and other processes for receiving survey measurements, verifying the survey measurements using one or more quality control metrics, alerting the rig if the survey measurements fail any of the quality control metrics, making the survey measurements available for corrective survey data analysis at a remote site, and making corrected survey measurements available for drilling of a wellbore at the rig. The database 104 is used to store raw survey data and corrected survey data. In one embodiment, the web application 102 and database 104 are deployed in a cloud 106. The term “cloud” is used in the sense that the web application 102 and database 104 are stored online and accessible via a standard web browser and Internet connection. The cloud 106 includes the necessary computing resources, such as processor(s) and memory, to run the web application 102 and database 104 on-demand. In one example, the cloud 106 may include an application server 108 that exposes the logic and processes of the web application 102 and a database server 110 that provides database services.

The web application 102 is accessible from a standard web browser on a client device 112. Interaction with the web application 102 occurs through an external graphical user interface (GUI) 116 or an internal GUI 118, either of which may be displayed in the web browser on the client device 112. The terms “external” and “internal” are arbitrary. Typically, the external GUI 116 will be displayed, to a user assigned a non-specialist role, typically a user at a rig site, and the internal GUI 118 will be displayed to a user assigned a specialist role, typically a user at a remote operating center. Access control 114 is used to restrict who can access the web application 102 through the external GUI 116 and internal GUI 118 and what features of the web application 102 can be accessed. Any authentication model suitable for use in a cloud environment may be used for the access control 114. Access control 114 may include displaying a login page in the web browser on the client device 112, receiving a user name and password from the browser, and checking the user name and password against an access control list to see if the user may access the web application 102 and what role the user has when accessing the web application 102.

In one embodiment, the web application 102 includes logic for receiving raw survey data through the external GUI 116. The web application 102 may further include logic for performing quality control (QC) checks on the raw survey data. The web application 102 may further include logic for storing QC verified survey data in the database 104. The web application 102 may further include logic for making the QC verified survey data available on the internal GUI 118. The web application 102 may further include logic for accepting corrected survey data through the internal GUI 118. The web application 102 may further include logic for performing QC checks on the corrected survey data. The web application 102 may further include logic for storing corrected survey data or QC verified corrected survey data in the database 104. The web application 102 may further include logic for making the corrected survey data available on the external GUI 116. The web application 102 may further include logic for generating context appropriate notifications and making them available on the client device 112 through either of the external GUI 116 and internal GUI 118.

In one embodiment, the web application 102 is provided as computer readable program instructions. In one embodiment, a computer program product includes a computer readable storage medium on which the computer readable program instructions are stored. The computer readable program instructions can be executed by one or more processors to cause a computer or computing environment, to perform the actions indicated in the instructions. Examples of computer readable storage media include, but are not limited to, CD-ROMS, flash drives, RAM chips, hard drives, EPROMs, etc. The computer readable storage medium on which the web application 102 is stored is non-transitory in that it does not include carrier waves and electronic signals passing wirelessly or over wired connections. In one embodiment, the computer readable program instructions representing the web application 102 can be downloaded from the computer readable storage medium to respective computing/processing devices or to an external computer or to an external storage device via a network.

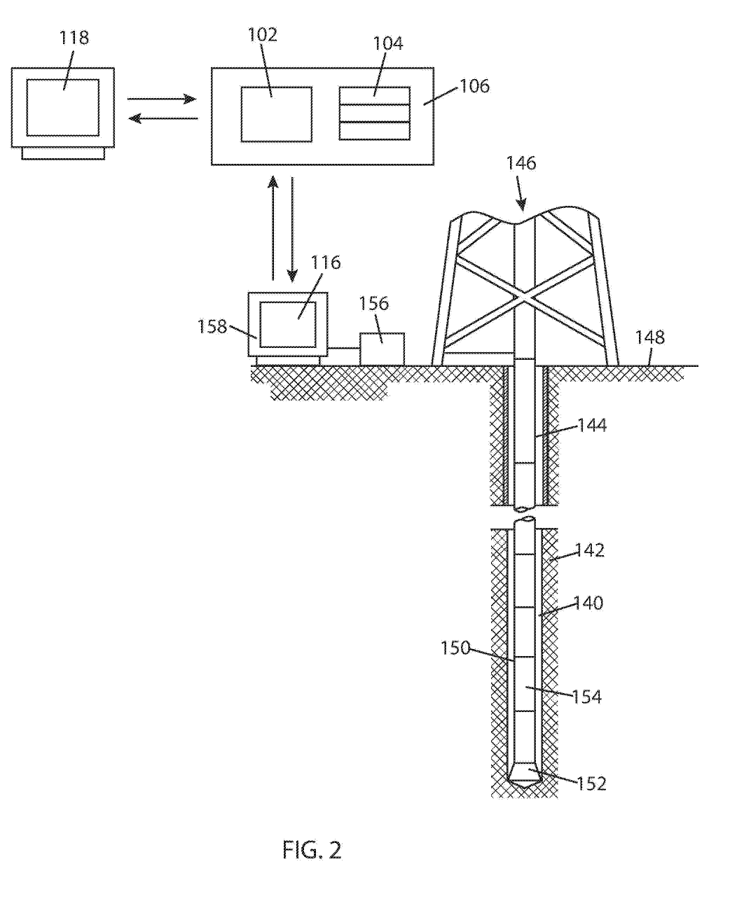

FIG. 2 shows a wellbore 140 drilled in a subsurface formation 142. A drill string 144 extends from a rig 146 at the surface 148 into the wellbore 146. A bottom-hole assembly (BHA) 150 is appended at the lower end of the drill string 144. The BHA 150 includes a drill bit 152 and, may further include one or more downhole tools configured to perform one or more downhole operations. In one example, the BHA 150 includes a MWD tool 154. The MWD tool 154 may include three accelerometers and three magnetometers positioned in three orthogonal axes for making survey measurements. The MWD tool 154 may be operated to make survey measurements at selected depths in the wellbore. The survey measurements may be sent to a MWD unit 156 on the rig 146 by suitable wellbore telemetry, such as mud pulse telemetry, wired drill pipe telemetry, or electromagnetic telemetry. The MWD unit 156 may include MWD decoding software for decoding the survey measurements. The survey data may be transmitted from the MWD unit 156 to a rig computer 158 and displayed on, the rig computer.

In one embodiment, a user on the rig 146 logs into the web application 102 from a standard browser. The standard browser may be accessed through the rig computer 158, for example. The web application presents an external GUI 116 to the user inside the browser. Through the external GUI 116, the rig user may enter the raw survey data into predefined fields or may upload an electronic file containing the raw survey data and then submit the data. The electronic file may be provided as a plain text file, a spreadsheet file, e.g., CSV file and the like, or a markup language file, e.g., XML file. Alternatively, an integration plug-in may be provided that enables the web application 102 to integrate with the MWD unit 156 and receive the survey data directly from the MWD unit 156 without requiring user input. The web application 102 may receive the survey data in response to a prompt from the user through the external GUI 118. The web application 102 may display the received data and allow the user to submit the data, e.g., by the click of a button on the external GUI 116. For MWD surveys, the submitted data may include the following: survey depth, inclination, azimuth, date, time, run number, survey type, X, Y, and Z accelerometer measurements, and X, Y, and Z magnetometer measurements. In addition, well information, such as well name, rig name, north reference, and survey tool type, may be provided to the web application along with the survey data.

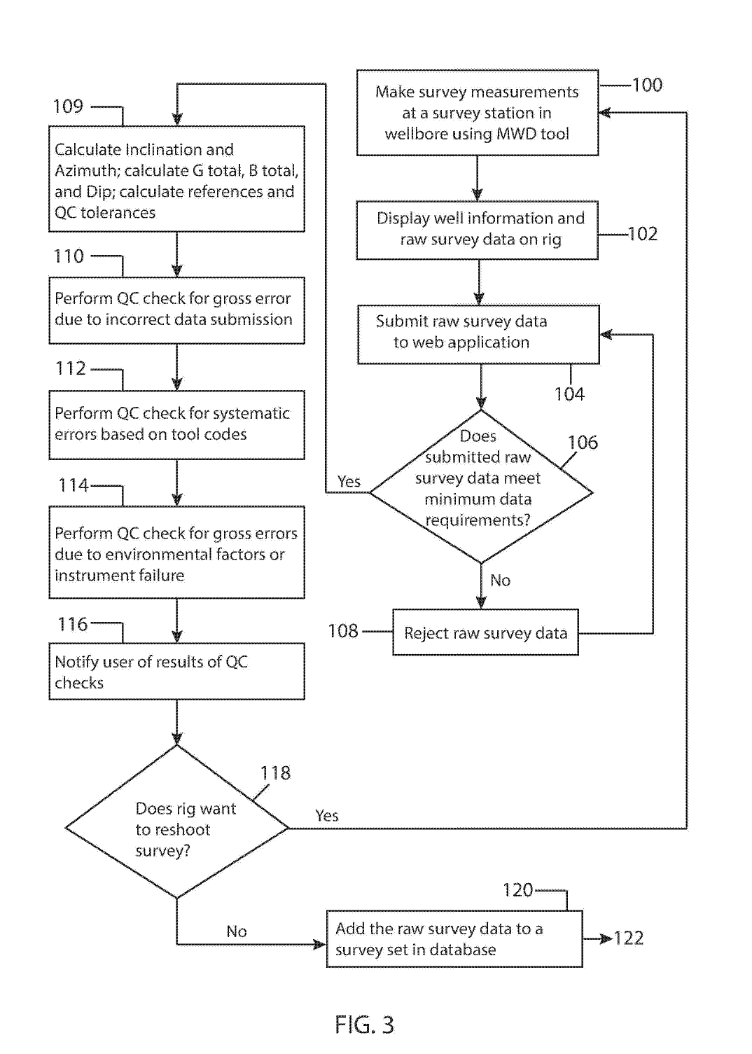

FIG. 3 is a flow chart illustrating an example process workflow for survey quality assurance and MWD data transfer using the survey quality assurance tool.

At 100, survey measurements are made at a survey station, or selected position, in the wellbore using the MWD tool.

At 102, the survey measurements are sent to the MWD unit on the rig and decoded. The raw survey data and well information are displayed on the rig computer.

At 104, the raw survey data is submitted to the web application. Any of the methods described above may be used to submit the raw survey data to the web application.

At 106, the web application, verifies that the submitted survey data meets minimum data requirements. At a minimum, the submitted survey data should include the survey depth, inclination, and azimuth and the corresponding B total, G total, and Dip or the 6 axis data (accelerometer and magnetometer measurements). If the submitted data does not meet the minimum data requirement, the web application, rejects the raw survey data, as shown at 108. At this point, new raw survey data may be submitted by returning to step 104.

At 109, if the submitted data meets the minimum data requirement, a set of parameters useful in QC validation of the survey data is calculated. The set of parameters may include inclination, azimuth, G total (strength of the gravity field), B total (strength of the magnetic field), and Dip (direction of magnetic field with respect to horizontal plane), reference values for total gravity, field strength, dip angle, declination, and grid convergence, and QC tolerances. Inclination and azimuth are calculated from the corresponding 6 axis accelerometer and magnetometer measurements if the 6 axis measurements are included in the submitted data. The QC tolerances are computed from the error coefficients specified in the tool code and scaled to the same sigma level used for collision avoidance planning. QC tolerances are calculated for measured depth, inclination, azimuth, Δ inclination, Δ azimuth, G total, B total, and Dip. QC tolerances can be calculated similarly to how measured depth, inclination and azimuth errors are calculated from tool code. (See, Maus, Stefan, Croke, Ryan. 2014. Field acceptance criteria based on ISCWSA tool error models. Presented at the ISCWSA meeting, Long Beach, 9 May 2014.)

At 110, a first QC check is made. The first QC check verifies that the submitted data is free of gross error due to incorrect data submission. Incorrect data submission may arise from the user entering the wrong data in the predefined fields in the external GUI or uploading the wrong file or a corrupt file through the external GUI. For the first QC check, if inclination and azimuth are calculated in step 109, the calculated inclination and azimuth (step 109) are compared to the rig reported inclination and azimuth (i.e., the inclination and azimuth stated in the raw survey data). If there are significant differences between the calculated inclination and azimuth and the rig reported inclination and azimuth, the submitted data will be considered as failing the first QC check. The first QC check also provides an independent check against the north reference, grid correction, and magnetic reference values being applied. North reference, grid correction, and magnetic reference are variables used to compute the azimuth. Thus if the calculated azimuth is correct, it can be concluded that the north reference, grid correction, and magnetic reference values being applied by the rig are correct.

At 112, a second QC check is made. The second validation check verifies that the survey QC measurements and systematic errors are within the QC tolerance limits computed at step 109. The survey measurement is validated against the tool code by evaluating differences between the measured values and reference values of B total, Dip, and G total, i.e., Δ B total, Δ Dip, and Δ G total, using the appropriate QC tolerances. If the Δ B total, Δ Dip, and Δ G total fall outside the calculated QC tolerance limits, then the survey measurement has greater error than what was modeled by the tool code EOUs and the anti-collision assessment may be invalid. If Δ B total, Δ Dip, and Δ G total fall outside the calculated QC tolerance limits, the submitted data will be considered as failing the second QC check.

At 114, a third QC check is made. The third QC check verifies that the data quality is adequate and free from gross errors due to environmental factors or instrument failure. The third QC check evaluates the current survey against the surveys taken at previous survey stations in order to identify trends that could alert the driller to gross errors indicative of external magnetic interference from offset well casing or a failing instrument. The third QC check may involve computing Δ B total, Δ Dip, and Δ G total (deltas) for each previous survey. These deltas or residuals will vary from one survey to the next. By evaluating the variances, the standard deviation across an entire data set consisting of the previous surveys can be calculated. The deltas for the current survey can be computed. The deltas for the current survey can be compared to the standard deviation to determine if the current survey is a statistical outlier. For example, if the differences between the deltas for the current survey measurements and the standard deviations exceed a certain threshold, such as 3 sigma, then the current survey could be considered a statistical outlier and suggest that there is a particular problem, such as poor telemetry decode or the BHA is in near proximity to an offset wellbore. If the current survey is a statistical outlier, the submitted data will be considered as failing the third QC check.

Although the terms first, second, and third QC checks are used, it should be clear that the QC checks can be performed in any order. Also, parts of step 109 can be completed while performing the QC checks.

At 116, the rig user is notified of the results of the QC checks. This may include displaying notices of any failed QC checks on the external GUI as well as displaying corresponding QC plots on the external GUI.

The QC checks of 110 to 116 can be fully automated and can occur almost as soon as the survey measurements are received on the rig. This allows an opportunity to give immediate feedback to the rig site personnel if there is a problem. Alerting the rig to potential problems in a timely manner creates an opportunity to reshoot the survey or elevate the concern to management before drilling begins again.

At 118, the process checks if the rig wants to reshoot the survey. If the rig does not want to reshoot the survey, the process goes to 120. If the rig wishes to reshoot the survey, e.g., because the survey data did not pass one or more of the QC validation tests, the process returns to 100.

At 120, the raw survey data is added to the survey set in the database. If the raw survey data failed any of the QC validation tests, the raw survey data may be flagged as such. Once the survey data is stored in the database on the cloud, the survey data can be accessed at a remote operating center through the internal GUI.

While the QC checks work well to detect potential problems in, the survey quality, it does very little to identify the underlying cause of the problem or distinguish between the various sources of error. However, the survey data can, be further evaluated using corrective survey data analysis techniques, such as multi-station analysis techniques, to determine individual error components attributed to sensor bias, scale, and misalignment. Trend analysis is also useful for recognizing patterns characteristic of magnetic drillstring interference, magnetic mud, and other environmental factors that contribute to survey error.

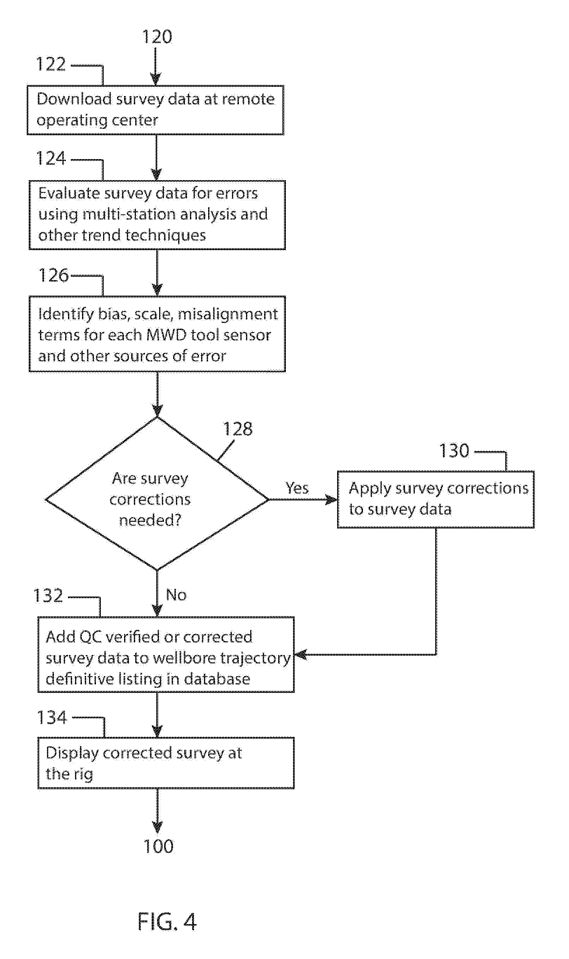

Referring to FIG. 4, at 122, a MWD specialist at a remote operating center downloads the survey data through the internal GUI.

At 124, the survey data is evaluated at the remote operating center. The survey data may be evaluated using one or more corrective survey data analysis techniques, such as multi-station analysis and other trend analysis techniques. Multi station analysis is a technique widely used in the industry to correct systematic errors of magnetic MWD surveys associated with drillstring interference. (See, Nyres, Erik, et, al., “Minimum Requirements for Multi-Station Analysis of MWD Magnetic Directional Surveys,” Presented at SPE/IARC Middle East Drilling Technology Conference & Exhibition held in Manama, Bahrain, 26-28, Oct. 2009, SPE/IARC 125677, and Brooks, A. G., et al., “Practical Application of a Multiple-Survey Magnetic Correction Algorithm,” Presented at the 1998 SPE Annual Technical Conference and Exhibition held in New Orleans, La., 27-30 Sep. 1998, SPE 49060.)

At 126, from the evaluation of 124, bias, scale, misalignment terms for each sensor in the MWD tool are identified. Other sources of error, i.e., drillstring interference, magnetic mud, and the like, are also identified.

At 128, the process involves checking if survey corrections are needed from the results of 126. If survey corrections are needed, the survey data is corrected at 130. The corrected survey data may be subject to QC checks similar to steps 110 through 114 in FIG. 3.

At 132, the QC-verified raw survey data or corrected survey data is added to the wellbore trajectory definitive listing in the database. The surveys on the wellbore trajectory definitive listing can be used to compute the wellbore trajectory during drilling of the wellbore.

At 134, the corrected survey data, or the last survey added to the wellbore trajectory definitive listing, is displayed at the rig using the external GUI. The process returns to 100 for the next survey measurement.

While the invention has been described with, respect to a limited number of embodiments, those skilled in the art of, having benefit of this disclosure, will appreciate that other embodiments can be devised which do not depart from the scope of the invention as disclosed herein. Accordingly, the scope of the invention should be limited only by the accompanying claims.

1. A method of improving quality of directional surveys, comprising:
with one or more processors, receiving from a first location raw survey data acquired by a survey tool configured to make a survey measurement from a wellbore;
with one or more processors, verifying the quality of the raw survey data using at least one quality control metric; and
with the one or more processors, storing the verified raw survey data in a database in a cloud.

2. The method of claim 1, further comprising, with the one or more processors, providing access to the verified raw survey data from a second location.

3. The method of claim 2, further comprising, with the one or more processors, receiving a corrected survey data from the second location, the corrected survey data being generated by applying at least one survey correction to the verified raw survey data at the second location; and
with the one or more processors, storing the corrected raw survey data in the database.

4. The method of claim 3, further comprising, with the one or more processors, displaying the corrected raw survey data at the first location.

5. The method of claim 3, further comprising, with the one or more processors, verifying the quality of the corrected, raw survey data using the at least one quality control metric.

6. The method of claim 1, further comprising, with the one or more processors, displaying an alert at the first location with a result of the verifying the quality of the raw survey data using at least one quality control metric.

7. The method of claim 6, further comprising, with one or more processors, receiving new raw survey data from the first location and repeating the verifying the quality of the raw survey data and storing the verified raw survey data with the new raw survey data.

8. The method of claim 1, wherein the at least one quality control metric is selected from (a) the raw survey data is free of gross error due to incorrect data submission, (b) systematic errors in the raw survey data are within quality control tolerance limits computed from a selected survey tool error model, and (c) the raw survey data is free of gross error due to instrumental failure or external magnetic interference.

9. The method of claim 1, wherein the at least one quality control metric is the raw survey data is free of gross error due to incorrect data submission, and wherein verifying the quality of the corrected survey data comprises;
with the one or more processors, computing inclination and azimuth from accelerometer and magnetometer measurements included in the raw survey data; and
with the one or more processors, comparing the computed inclination and azimuth to the inclination and azimuth reported in the raw survey data.

10. The method of claim 1, wherein the at least one quality control metric is the raw survey data is systematic errors in the raw survey data are within quality control tolerance limits computer from a selected survey tool error model, and wherein verifying the quality of the corrected survey data comprises:
computing quality control tolerances for each of B total, Dip, and G total from the survey tool error model, where B total is strength of the magnetic field, Dip is direction of magnetic field with respect to horizontal plane, and G total is strength of the gravity field; and
determining if the differences between measured values and reference values of B total, Dip, and G total fall within the corresponding quality control tolerances.

11. The method of claim 1, wherein the at least one quality control metric is the raw survey data is free of gross error due to instrumental failure or external magnetic interference, and wherein verifying the quality of the corrected survey data comprises:
computing standard deviations of the differences between measured values and reference values of B total, Dip, and G total for each survey station in a set of previous surveys made by the survey tool in the wellbore, where B total is strength of the magnetic field, Dip is direction of magnetic, field with respect to horizontal plane, and G total is strength of the gravity field;
computing differences between measured values and reference values of B total, Dip, and G total for the raw survey data; and
comparing the differences between measured values and reference values of B total, Dip, and G total for the raw survey data to the standard deviations to determine if the raw survey data is a statistical outlier.

12. A method of improving quality of directional surveys, comprising:
making a survey measurement at a selected position in a wellbore using a survey tool arranged in the wellbore;
extracting raw survey data from an output of the survey tool at a first location; and
submitting the raw survey data to a web application from the first location, thereby causing the web application to:
receive the raw survey data from the first location;
verify the quality of the raw survey data using at least one quality metric; and
add the verified raw survey data to a database;

13. The method of claim 12, further comprising retrieving the verified survey data from the database from a second location that is remote to the first location.

14. The method of claim 13, further comprising performing at least one corrective survey data analysis on the verified survey data.

15. The method of claim 14, further comprising applying at least one survey correction to the verified survey data based on a result of the at least one corrective survey data analysis.

16. The method of claim 15, further comprising submitting the corrected survey data to the web application, thereby causing the web application to:
add the corrected survey data to the database; and
display the corrected survey data at the first location.

17. A computer program product including non-transitory computer readable medium and computer readable code embodied on the non-transitory computer readable medium for improving quality of directional surveys, the computer readable code comprising:
computer readable program code adapted to cause a computer to effect receiving raw survey data from a first location;
computer readable program code adapted to cause a computer to effect verifying the quality of the raw survey data using at least one quality control metric; and
computer readable program code adapted to cause a computer to effect storing the verified raw survey data in a database in a cloud.

18. The computer program product of claim 17, further comprising computer readable program code adapted to cause a computer to effect receiving a corrected survey data from a second location, the corrected survey data being generated by applying at least one survey correction to the verified raw survey data at the second location.

19. The computer program product of claim 18, further comprising computer readable program code adapted to cause a computer to effect storing the corrected raw survey data in the database.

20. The computer program product of claim 19, further comprising computer readable program code adapted to cause a computer to effect displaying the corrected raw survey data at the first location.

21. The computer program product of claim 17, further comprising computer readable program code adapted to cause a computer to effect reporting a result of verifying the quality of the raw survey data to the first location.

22. The computer program product of claim 18, further comprising computer readable program code adapted to cause a computer to effect verifying the quality of the corrected survey data.

23. The computer program product of claim 17, wherein the at least one quality control metric is selected from (a) the raw survey data is free of gross error due to incorrect data submission, (b) systematic errors in the raw survey data are within quality control tolerance limits computed from survey tool error model, and (c) the raw survey data is free of gross error due to instrumental failure or external magnetic interference.

24. The computer program product of claim 23, wherein the at least one quality control metric is the raw survey data is free of gross error due to incorrect data submission, and wherein verifying the quality of the corrected survey data comprises:
computing inclination and azimuth from accelerometer and magnetometer measurements included in the raw survey data; and
comparing the computed inclination and azimuth to the inclination and azimuth reported in the raw survey data.

25. The computer program product of claim 23, wherein the at least one quality control metric is the raw survey data is systematic errors in the raw survey data are within quality control tolerance limits computer from a selected survey tool error model, and wherein verifying the quality of the corrected survey data comprises:
computing quality control tolerances for each of B total, Dip, and G total from the survey tool error model, where B total is strength of the magnetic field, Dip is direction of magnetic field with respect to horizontal plane, and G total is strength of the gravity field; and
determining if the differences between measured values and reference values of B total, Dip, and G total fall within the corresponding quality control tolerances.

26. The computer program product of claim 23, wherein the at least one quality control metric is the raw survey data is free of gross error due to instrumental failure or external magnetic interference, and wherein verifying the quality of the corrected survey data comprises:
computing standard deviations of the differences between measured values and reference values of B total, Dip, and G total for each survey station in a set of previous surveys made by the survey tool in the wellbore, where B total is strength of the magnetic field, Dip is direction of magnetic, field with respect to horizontal plane, and G total is strength of the gravity field;
computing differences between measured values and reference values of B total, Dip, and G total for the raw survey data; and
comparing the differences between measured values and reference values of B total, Dip, and G total for the raw survey data to the standard deviations to determine if the raw survey data is a statistical outlier.

27. A system for improving quality of directional surveys, comprising:
a database located in a cloud;
one or more processors operating to:
receive raw survey data from a first location;
verify the quality of the raw survey data using at least one quality control metric;
store the verified raw survey data in the database;

28. The system of claim 27, further comprising the one or more processors operating to receive a corrected survey data from a second location, the corrected survey data being generated by applying at least one survey correction to the verified raw survey data at the second location.

29. The system of claim 28, further comprising the one or more processors operating to store the corrected raw survey data in the database.

30. The system of claim 28, wherein the at least one survey correction, is determined from a multi-station analysis of the verified raw survey data.

31. The system of claim 29, wherein the one or more processors operate to display the corrected raw survey data at the first location.

32. The system of claim 27, wherein the one or more processors operate to report a result of verifying the quality of the raw survey data at the first location.

33. The system of claim 27, wherein the at least one quality control metric is selected from (a) the raw survey data is free of gross error due to incorrect data submission, (b) systematic errors in the raw survey data are within quality control tolerance limits computed from survey tool error model, and (c) the raw survey data is free of gross error due to instrumental failure or external magnetic interference.
